(19) United States
(12) Patent Application Publication
(10) Pub. No.: US 2012/0067016 A1
(43) Pub. Date: Mar. 22, 2012

(54) AIR FILTER GROUP FOR MOTOR VEHICLES AND A FILTER ELEMENT

(76) Inventor: Giorgio Girondi, Mantova (IT)

(21) Appl. No.: 13/265,730

(22) PCT Filed: Apr. 14, 2010
(86) PCT No.: PCT/EP2010/054898

§ 371 Date: Nov. 14, 2011

(30) Foreign Application Priority Data
Apr. 27, 2009 (IT) RE2009A000041

(51) Int. Cl. B01D 46/52

(52) U.S. Cl. 55/494; 55/502; 55/500; 55/521

(57) ABSTRACT

An air filter group for motor vehicles includes a box body, provided with at least an air inlet opening and an air outlet opening, and further includes a filter element configured to be located internally of the box body, in which the air outlet opening is configured such as to receive the filter element from the outside of the box body, and in that the filter element includes a seal on an end side thereof. The seal being provided with a border configured to be at least partially rested on the edge of the air outlet opening and being such as to enable fastening the filter element to the box body, the filter element being maintained in position by compression directly by the conveyor of the clean air outlet.

The invention relates to an air filter group for motor vehicles. The invention also concerns a filter element to be used internally of an air filter group.

As is known, at present, in motor vehicle engine compartments, a casing or similar containing body is used for containing some of the components provided in the engine compartment, such as for example the air filter box, such as to protect these elements and lend a certain aesthetic appeal to the compartment itself.

In general, in order to attain an aesthetic function, the in-view surface of the casing will preferably not display dents, scratches or other surface defects due to moulding or manipulation; for this reason there must not be too-deep ribbings, nor should there be welding seams in view or other visually-disturbing elements.

Known filter elements must be fixed to the lower part, not in view, of the casing surface, and the fastening of the elements can therefore give rise to aesthetically unattractive results on the external surface of the casing.

Also, some known filter elements have a star configuration and are inserted in a cartridge having a circular or elliptic section; these elements necessarily are large; this fact leads to problems in providing that the volume occupied by the casing responds to ever-more stringent requirements of layout and volumes.

An aim of the present invention is to realise a filter group which can be integrated optimally internally of the engine compartment of a motor vehicle, reducing volumes and sizes as much as possible.

A further aim of the invention is to realise a filter group which avoids negatively influencing the aesthetic effect of the engine compartment.

These aims are attained by the present invention which has as object an air filter group for motor vehicles, comprising a box body, provided with at least an air inlet opening and an air outlet opening, and further comprising a filter element destined to be located internally of the box body, characterised in that the air outlet opening is conformed such as to receive the filter element from the outside of the box body, and in that the filter element exhibits a seal on an end side thereof, the seal being provided with a border destined to be at least partially rested on the edge of the opening and being such as to enable fastening the filter element to the box body and maintaining it in position by compression directly by the conveyor of the clean air outlet.

In a further realisation of the element, the air filter group for motor vehicles, comprises a tray provided with at least an air inlet opening and an air outlet opening, and further comprises a filter element destined to be located internally of the tray, and is characterised in that the tray is covered by a shaped surface having an aesthetic function and also being a protection.

The shaped surface is preferably smooth in an external part thereof.

The invention also concerns a filter element to be used with an air filter group for motor vehicles, characterised in that it, in working configuration, comprises a filter wall having a substantially parallelepiped conformation, the filter wall exhibiting at least a sheet of folded paper, in which the sheet is folded on itself in a first and second layer thereof, which layers are opposite one another, and in which each of the layers exhibits an undulated configuration constituted by a plurality of folds.

Working configuration means the configuration assumed by the filter element when it is actually used with the air filter group, in order to filter the air.

Further characteristics of the invention are delineated in the dependent claims.

Further characteristics and advantages of the invention will emerge from a reading of the following description, provided by way of non-limiting example with the help of the accompanying figures of the drawings, in which:

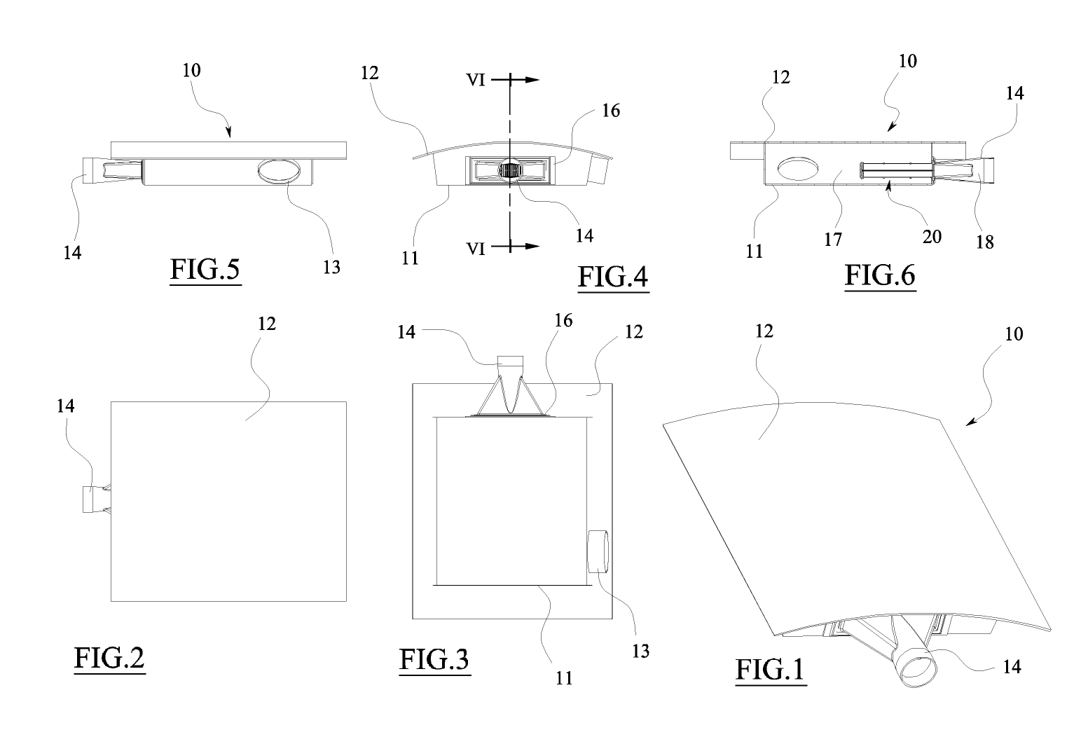

FIG. 1 is an axonometric view of the filter group of the invention;

FIGS. 2 and 3 are respectively a view from above and a view from below of the filter group of FIG. 1;

FIGS. 4 and 5 are respectively a front view and a side view of the filter group;

FIG. 6 is a section view of the filter group along plane VI-VI of FIG. 4;

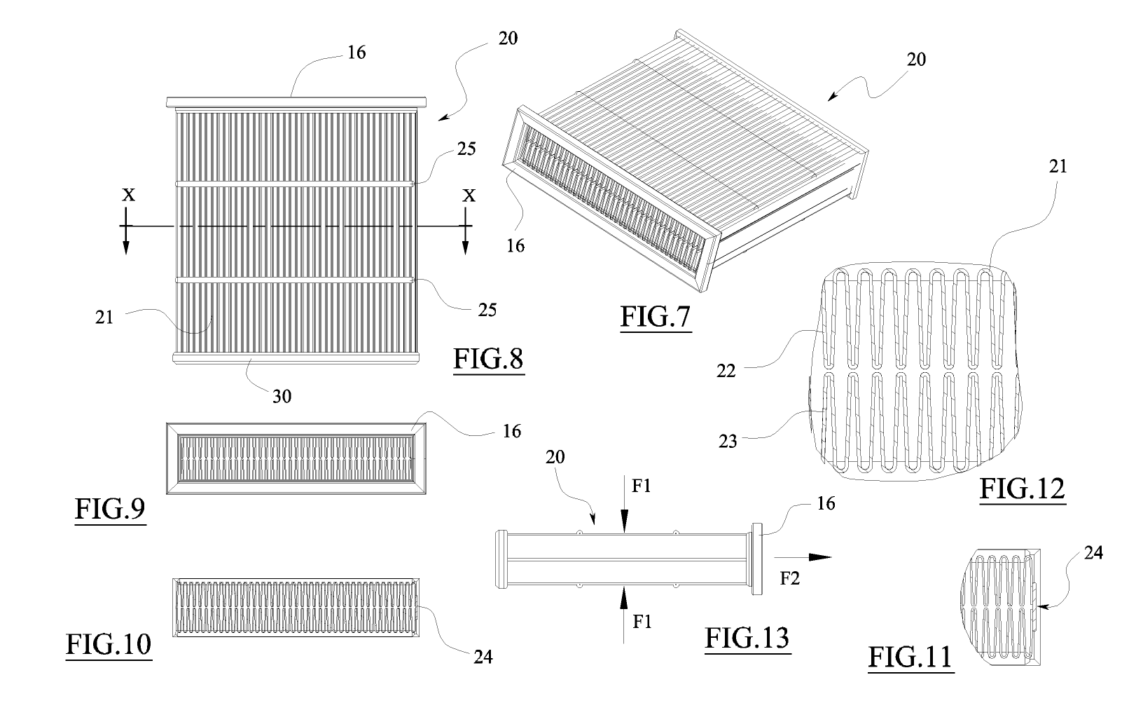

FIG. 7 is an axonometric view of a filter element especially designed for the filter group of the invention;

FIG. 8 is a view from above of the filter group of FIG. 7;

FIG. 9 is a front view of the filter element of FIGS. 7-8;

FIG. 10 is a section view of the filter element along plane X-X of FIG. 8;

FIG. 11 is a first detail in section of the filter element of FIGS. 7-10;

FIG. 12 is a second detail in section of the filter element of FIGS. 7-10; and

FIG. 13 is a lateral view of the filter element, with an indication of the air flows crossing it.

Firstly, FIGS. 1-6 detail a filter group of the present invention, denoted in its entirety by reference number 10. The filter group is made up of a closed box body 11 composed by a housing tray for covering and containing the filter element, the tray being closed by a shaped surface 12 which is an aesthetic protection.

The lateral walls of the housing tray define the lateral walls of the filter box 11, which is therefore not very developed in height.

The shaped surface 12 is preferably smooth externally.

As can be seen in FIG. 3, the box body 11 is provided with an inlet 13 for dirty air and an outlet 14 for clean air that has been filtered by the filter element.

During mounting, the filter element can be inserted from outside and on an end side exhibits a seal 16 which is held in direct compression by the conveyor of the outlet 14 of the clean air 18.

The outlet 14 is located on a lateral wall of the housing tray, so that also the seal zone is located on said lateral wall.

Also the inlet 13 is either located on a lateral wall of the housing tray.

In more detail, the seal 16 is provided with an edge destined to be rested at least partially on the border of the opening defining the clean air outlet, and is such as to enable fastening the filter element to the box body, as it is held in position by compression, directly by the conveyor of the clean air outlet.

As can be seen in FIG. 6, the special construction of the filter group of the invention avoids the need for a seal between the aesthetic cover and the filter, as the interface zone is on the dirty air side 17. In this way there is no need to introduce welding seams and reinforcing ribs on the shaped surface 12.

As regards the filter element itself, illustrated in FIGS. 7-13 and denoted by reference number 20, the filter element generally has one only sheet of folded paper 21, in which the sheet is folded such as to assume a conformation exhibiting a first and a second layer 22, 23 which are opposite one another and in which each of the layers exhibits an undulated configuration constituted by a plurality of folds.

Further, as illustrated in FIG. 11, in the configuration of the single layer of folded paper 21 the folded paper 21 itself is closed at an end side by a base 24 which can be glued or provided with adhesive or another joining means with the layer of folded paper 21.

The filter element is thus constituted by a volume closed by the two layers of undulated or pleated paper, closed at ends thereof; the filtered air zone is closed by these two layers.

In substance the filter direction is from the outside towards the inside, and the filtered air exits from the side, as illustrated for example in FIG. 13, in which the arrows F1 indicate the flow of entering air, and the arrow F2 indicates the outlet flow. The filtered air zone is comprised between the two series of folds. It is also possible to superpose the folds, thus further reducing the height of the panel while providing the same filtering surface; in this case there will be a reduction in the air-crossing section.

In a variant of the invention, two sheets of folded paper are provided, located one above the other and subsequently folded in the described conformation. Further, the layer of folded paper 21 is preferably reinforced above and below by transversal strips 25 which are joined, for example by heat-welding, to the crests of the layer of folded paper. The structural function is performed by hot-melt drops (at least two per side) arranged in a perpendicular direction with respect to the folds in the paper.

A rear side of the filter element is closed by a bottom 30 made of polyurethane, while the clean air outlet side has a polyurethane crown seal. The filter element thus exhibits a seal on the smaller sides thereof; thus the seal is limited to the smaller side of the element.

Given the simplicity of the solution, and the fact that the filter element is constituted by a wall fashioned by a single sheet of pleated paper, this type of panel filter element can be realised using the same apparatus as for standard panels or filter elements. Thanks to this type of filter element the shape of the filter body can be significantly changed, as the seal zone can also be located on the lateral walls and on the smaller sides of the filter box.

A peculiarity of this solution consists in the fact that it can be easily produced using a production process and apparatus for the creation of standard air filter panels.

With respect to cylindrical cartridge filter elements with a head seal, as in the prior art, the present panel filter element enables access to the filter element from outside, as the filter element can be mounted and demounted without having to deassemble the body and the filter box lid. Only the clean air conveyor has to be removed.

A further advantage of the present panel filter element with respect to a head seal cartridge element consists in the possibility of having much smaller size in terms of height, while not reducing the filter surfaces.

This solution enables producing a filter box which is not very developed in height, in which the aesthetic protection and the rest of the filter box are in the dirty air zone: thus it is not necessary to provide seals or welds which guarantee the seal on the filter box-aesthetic cover interface zone.

Thus the upper surface of the casing can also be made with the desired aesthetic qualities.

The structural and layout advantages are evident: the aesthetic cover is made without welding and structurally-necessary details for keepting the seal or other element under compression.

Obviously modifications or improvements dictated by contingent or special motivations might be brought to the invention without its forsaking the ambit of the invention as claimed herein below.

1. An air filter group (10) for motor vehicles, comprising a box body (11) , provided with at least an air inlet opening and an air outlet opening, and further comprising a filter element (20) adapted to be located internally of the box body (11), wherein the air outlet opening is configured such that the filter element (20) can be located internally of the box body (11) by inserting the filter element (20) in the air outlet opening from the outside of the box body (11), and the filter element comprises a seal (16) on an end side thereof, the seal (16) being provided with a border configured to be at least partially rested on an edge of the air outlet opening and being such as to enable fastening of the filter element (20) to the box body and being maintained in position by compression directly by an outlet conveyor (14) of the clean air outlet (18).

2. The filter group (10) of claim 1, wherein the filter element (20) comprises a filter wall having a substantially parallelepiped conformation, the filter wall comprising at least a sheet of folded paper (21), in which the sheet is folded on itself into a first and a second layer (22, 23), opposite one another, and in which each of the layers comprising an undulated configuration constituted by a plurality of folds.

3. The filter group (10) of claim 2, wherein the conformation of the sheet of folded paper (21) comprises the sheet of folded paper (21) being closed at an end side thereof by a base (24) which can be glued or provided with adhesive or a further connector with the layer of folded paper (21).

4. The filter group (10) of claim 2, wherein the sheet of folded paper (21) is superiorly and inferiorly reinforced by transversal strips (25) joined to external crests of the two layers of undulated folded paper.

5. The filter group (10) of claim 4, wherein the transversal strips (25) are joined by heat-welding to the external crests of the two layers (22, 23) of paper.

6. The filter group (10) of claim 5, wherein a posterior side of the filter element is closed by a bottom (30), while a clean air outlet side comprises a seal configured to interface with an air outlet opening in a filter group.

7. The filter group (10) of claim 1, wherein the box body (11) comprises a tray, provided with the at least an air inlet opening and the air outlet opening, the filter element (20) being configured to be internally located in the tray, the tray being covered by a shaped surface (12) having an aesthetic protection function.

8. The filter group (10) of claim 7, wherein the shaped surface (12) is smooth in an external part thereof.

9. The filter group (10) of claim 7, wherein the shaped surface (12) having an aesthetic protection function is fixed to the box body by welding or gluing.

10. The filter group (10) of claim 7, wherein the filter element comprises a substantially parallelepiped conformation.

11. The filter group (10) of claim 7, wherein said at least an air outlet opening is located on a lateral wall of the tray.

12. The filter group (10) of claim 1, wherein the seal (16) of the filter element (20) is rested on the outside of the box body (11).

13. A filter element (20) to be used with an air filtering group for motor vehicles, wherein, in working configuration, the filter element (20) comprises a filter wall having a substantially parallelepiped conformation, the filter wall comprising at least a sheet of pleated paper (21) folded on itself in a first layer and a second layer (22, 23), superposed on one another, in which each of the layers comprises a pleated configuration constituted by a plurality of folds.

14. The filter element (20) of claim 13, wherein the conformation of the folded sheet (21) is such that it is closed at an end side thereof by a base (24) which can be glued or provided with adhesive or another connector with the layer of folded paper (21).

15. The filter element (20) of claim 13, wherein the sheet of folded paper (21) is superiorly and inferiorly reinforced by transversal strips (25) joined to external crests of the two layers of undulated folded paper.

16. The filter element (20) of claim 15, wherein the transversal strips (25) are joined by heat-welding to the external crests of two layers (22, 23) of paper.

17. The filter element (20) of claim 13, wherein a posterior side of the filter element is closed by a bottom (30), while the clean air outlet side comprises a seal configured to interface with an air outlet opening in a filter group such as to realise therewith a seal by compression directly by the outlet conveyor (14) of the clean air outlet (18).
